(19) United States
(12) Patent Application Publication
(10) Pub. No.: US 2015/0217488 A1
(43) Pub. Date: Aug. 6, 2015

(54) METHOD AND APPARATUS FOR RAPID MOLDING A COMPOSITE STRUCTURE

(71) Applicant: FIVES MACHINING SYSTEMS, INC., Fond du Lac, WI (US)

(72) Inventors: Daniel Allman, Hebron, KY (US); Richard A. Curless, Cincinnati, OH (US)

(21) Appl. No.: 14/426,075

(22) PCT Filed: Sep. 9, 2013
(86) PCT No.: PCT/US2013/058759

§ 371 Date: Mar. 4, 2015

Related U.S. Application Data
(60) Provisional application No. 61/698,130, filed on Sep. 7, 2012.

(51) Int. Cl. B29C 43/18; B29C 43/20

(52) U.S. Cl. CPC B29C 43/18; B29C 43/203; B29C 2043/189; B29K 2063/00

(57) ABSTRACT

A method for molding a composite structure includes the steps of infusing a fabric with a resin to form a ply of composite material, transferring the ply of composite material to a preheat station, and preheating the ply of composite material to a temperature that renders the composite material more drapable, but is less than a temperature that causes the resin in the material to initiate polymerization. The ply of composite material is then transferred to a press station where it is heated to a temperature that causes the resin to initiate polymerization, whereby the curing time for the composite material is substantially less than the curing time of a fabric that is infused with an epoxy resin.

### FIELD

The device relates to a method and apparatus for rapid molding composite parts in which part shapes are cut from a pre-impregnated continuous fiber reinforced material to form a charge, the charge is held in tension while it is preheated to a certain temperature, and the preheated charge is placed in a forming and curing tool where tension is applied to the charge while the heated tool halves are closed and the part is rapidly cured.

### BACKGROUND

The cost effective production of parts for the automotive industry is dependent on efficient repeatable manufacturing processes that deliver quality parts at a high volume. In order to meet cost and quality demands in the automotive market, it is necessary to constantly re-invent manufacturing technologies. Additionally the global automotive market is seeking “light-weighting” materials and manufacturing technologies that enable mass and weight reduction to improve fuel efficiencies. The composites (fiber reinforced materials) industry has a long history in supplying automotive parts primarily for lower volume vehicles such as the Chevrolet Corvette and Dodge Viper. However, traditional composite processes such as Sheet Molding Compound (SMC) and Long Fiber Thermoplastic (LFT) utilize discontinuous fibers that significantly reduce the strength and stiffness of the materials. Processes such as Resin Transfer Molding (RTM) can utilize a continuous (dry) fiber, but RTM processes have historically failed to support the quality and manufacturing efficiencies demanded by automotive OEM's. Long cycle times, high labor content, and high scrap and rework costs are typical when attempting rapid cycle RTM processes. Continuous fiber materials offer the highest level of light-weighting capability available to the automotive industry. Although utilized extensively by the aerospace industry for their light-weighting benefits, continuous fiber materials have realized few applications in the automotive industry due to slow and labor intensive manufacturing processes. To utilize continuous fiber technology beyond the automotive industries niche market volumes, and meet the auto industry's part quality and cycle efficiencies requirements, new manufacturing methods and mechanisms are required. Continuous fiber reinforcements such as glass, carbon or other reinforcements that are pre-impregnated with a thermoset or in some cases a thermoplastic polymer are known as prepreg. In order to achieve the desired strength and stiffness, a number of prepreg plies are often stacked together to form a “charge”. The fibers are oriented in the direction of the structural load the part will experience in use and under crash conditions. Once the charge is assembled, maintaining the proper alignment and orientation of the fibers during handling and the subsequent multiple processing steps to produce the final part requires a unique and innovative material and manufacturing solution.

It would accordingly be desirable to provide a method and apparatus for producing composite parts that would enable the plies and fibers of a charge to be maintained in the proper orientation and in alignment with one another prior to the charge being delivered into a forming and curing tool.

It would also be desirable to utilize a method and apparatus for producing composite parts that would enable the plies and fibers of a charge to be maintained in the proper orientation after the charge is placed into a forming and curing tool and the mold halves are closed onto the charge.

It would further be desirable to utilize a method and apparatus for producing thermoset composite parts that would shorten the cycle time required to cure the resin in a part in a forming and curing tool.

### BRIEF DESCRIPTION OF THE DRAWINGS

FIGS. 1A and 1B are plan views of an automated facility for manufacturing composite parts.

FIGS. 2A and 2B are side views of the automated facility of FIGS. 1A and 1B.

FIG. 3 shows a ply of material cut from a continuous fabric of composite material with the fibers running in a first direction.

FIG. 4 shows a ply of material cut from a continuous fabric of composite material with the fibers running in a second direction.

FIG. 5 shows the steps of a process for manufacturing a composite part using a thermoset resin.

FIG. 6 shows the steps of a process for manufacturing a composite part using a thermoplastic resin.

### DESCRIPTION OF THE PREFERRED EMBODIMENT

Fiber reinforcement(s) are impregnated with either a thermoset or thermoplastic resin to form a prepreg material. The prepreg may comprise reinforcing fiber such as glass, carbon, or other fibers commonly used in composite structures, or a combination thereof, as known to those skilled in the art. The prepreg may also be reinforced with Basalt, natural or other fibers. The resin may comprise a single resin that may be a thermosetting resin of a vinyl ester. A thermosetting resin such as a vinyl ester provides the following advantages: the resin is solid at room temperature, the resin has a shelf life of ten months, and the resin has a rapid cure time in the mold. A thermosetting, vinyl ester resin that cures, or polymerizes, at approximately 300° F. enables the rapid cycle efficiencies similar to a thermoplastic polymerprocess. The prepreg material may be wound onto a roll for storage at room temperature, and later handling in a manufacturing process.

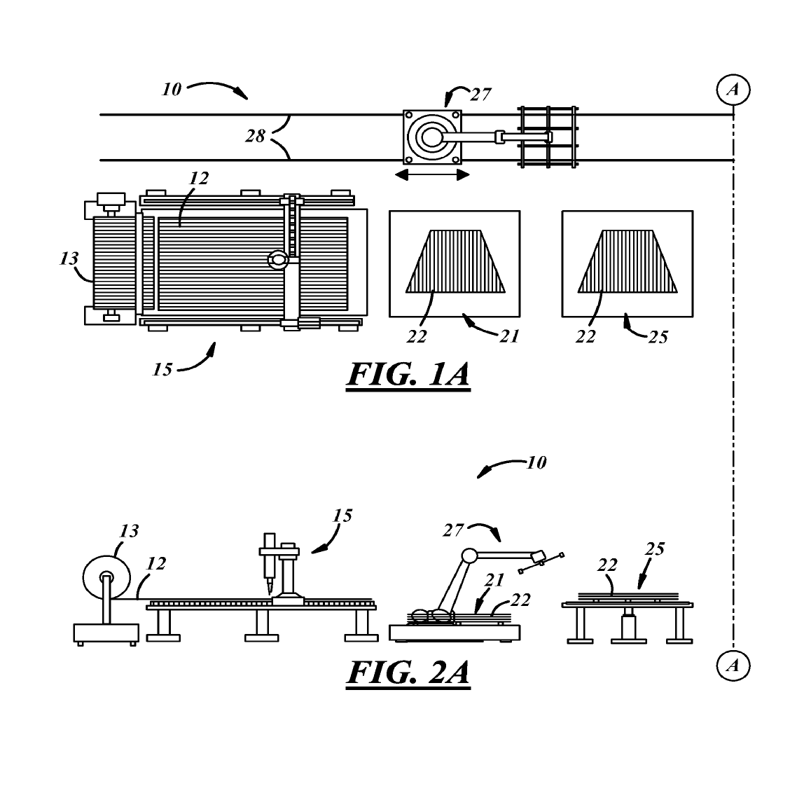

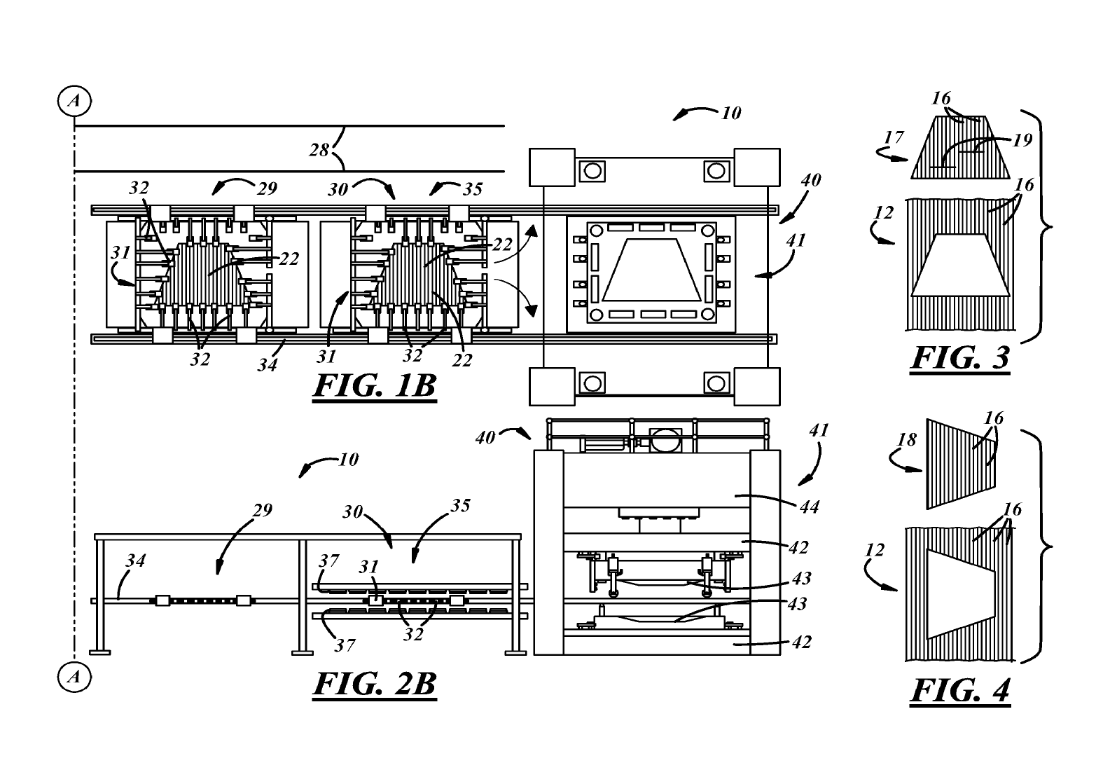

As shown in FIGS. 1A, 1B, 2A and 2B, an automated line for the production of composite parts is generally designated by the reference numeral 10. The prepreg material 12 may be delivered from a roll 13 as a broadgood to a cutting station 15 where the prepreg may be cut into net or near net shaped pieces that may be combined to form finished parts. The cutting station 15 may be used to cut the composite material 12 from the roll 13 into plies having shapes that may be similar to the final shape of a part. The cutting station 15 may cut several plies of the composite material 12 to the same shape. As shown in FIGS. 3 and 4, the prepreg material 12 may be cut so that the fibers 16 in each cut piece 17 and 18 are oriented in the desired direction in order to impart the required strength characteristics to the finished part. The cutting station 15 may also be used to make selective relief cuts 19 in the plies of composite material 12 to enable the material 12 to be molded into a final shape without exerting excess stress on the fibers in the plies. The width and thickness of the composite prepreg material 12 may be determined by the overall “string” dimensions of the part geometry being considered for production.

The cut pieces 17 and 18 may be transferred to a pre-consolidation station 21 until the desired number of fabric layers or plies are assembled. The plies may be consolidated to form a charge 22, and individual charges 22 may be transferred to a stacking station 25 for later processing. The pre-consolidation of cut pieces 17 and 18 into charges 22 may be achieved by stacking the individual plies on top of one another, since the tack properties of the vinyl resin will enable the individual plies 17 and 18 to adhere to one another. The pre-consolidation may also be achieved by applying a light pressure in the range of 1-300 PSI to a stack of plies. The wide range of consolidation pressures is driven by the nature of the specific polymer, formulation and fiber volume fraction selected for the specific application and end use requirements. For example, a low tack epoxy material will have a higher consolidation pressure in the range of 200-300 PSI, and a high tack vinyl ester will have a lower consolidation pressure in the range of 1-50 PSI. Additionally a high fiber loaded composite will have a higher consolidation pressure in the range of 150-200 PSI, while a low fiber loaded material will have a lower consolidation pressure in the range of 100-150 PSI. Transfer of the cut pieces from the cutting station 15 to the pre-consolidation station 21, and from the pre-consolidation station to the stacking station 25, and to other stations downstream from the stacking station, may be performed by a robot 27 which may be mounted on rails 28, or other material handling device, or the transfer may be performed manually, without departing from the spirit of the present disclosure.

Individual charges 22 from the stacking station 25 may be taken to a loading station 29 where they are loaded into a cassette 31. The cassette 31 surrounds the charge 22 and allows secure automated handling and positioning of the charge through subsequent steps of the process. The cassette 31 may have sets of discrete grippers 32 that engage the charge 22 on two opposite ends, or around the entire periphery of the charge 22, and pull on the charge to place the charge in tension. The grippers 32 may be used to hold the plies and fibers 16 of a charge 22 in the proper orientation and in alignment with one another prior to the charge being placed into a forming and curing tool downstream from the loading station 29. The tension may be from 0.1 lb to 10 lbs, and more particularly from 3-10 lbs. In one embodiment, the tension of 2 lbs was employed. The tension exerted by the grippers 32 may vary across the surface of the charge 22 depending on the final shape of the part.

The charge 22 in the tension cassette 31 may then be transferred to a preheating station 30 where it is pre-heated in a preheating oven 35 to a preheat temperature between 100° to 500° F. while it is being held in tension by the grippers 32. The wide process temperature range is determined by the polymer selected and the temperature range at which the polymer experiences a phase change thus enabling high drapability or formability of the next step of the process. For example, a polymer can be formulated to soften at a temperature of 140° F. or the same polymer can be formulated to soften at 200° F. The performance specifications for the formed part will determine the specific formulation. Typically a high glass transition temperature material will have a higher process temperature than the same polymer with a lower glass transition temperature due to the cross link density of the system. The pre-heating oven 35 may use quartz or radiant heating elements 37 that may be individually controlled to create heating zones within the oven 35 in order to heat selected sections of the charge to control drapability.

Pre-heating the prepreg while the material is held in the tension cassette 31 increases the formability and drapability of the charge 22 so that the composite material will more readily conform to the final shape of the molded part in the downstream form and cure tool 41 without disturbing the orientation and placement of the fibers 16 in the individual layers or plies 17 and 18. Pre-heating the charge 22 prior to molding will also change the thermosetting resin from a solid to a liquid state, thus minimizing the influence of the resin's viscosity on the drapability of the layered composite material during the molding process. In one embodiment, the pre-heating oven 35 may be used to increase the temperature of the thermoset prepreg charge to a preheat temperature of 150° F. The pre-heating also reduces the cure time of the end product in the form and cure tool 41 since the time required to increase the temperature of the charge 22 to initiate the polymerization phase will be less than if the material was introduced into the form and cure tool 41 at ambient temperature. The preheat temperature is not high enough to initiate the free radical initiation/polymerization phase of the polymer in the vinyl ester resin. After pre-heating, the grippers 32 in the cassette 31 may continue to hold the charge 22 in tension while the charge is transferred to the form and cure tool 41. An indexing conveyor 34 may be used to transfer the cassette 31 with the charge 22 from the loading station 29 to the preheat station 30 and from the preheat station 30 to a press station 40.

The pre-heated charge 22 may then be transferred from the preheat station 30 to the press station 40 where it may be placed into a heated form and cure tool 41. The form and cure tool 41 may comprise a press 44 with opposed platens 42 and matched metal dies 43. For a thermoset polymer the temperature of the metal dies 43 may be set or ramped up to 350° F., and more particularly 225-300° F. to initiate the polymerization phase of the resin in the charge 22. Once the charge 22 is placed in the form and cure tool 41 and the metal dies 43 close on the charge 22, the tension grippers 32 may release the charge 22 so that it can be molded by the metal dies 43 into its final shape. The cassette 31 and the tension grippers 32 may then be returned to the stacking station 25 to pick up the next charge. Pressure on the charge 22 in the form and cure tool 41 is adjustable from 10 PSI to 1000 PSI, and more particularly from 100-300 PSI. The forming pressure will vary based on the polymer selected and the fiber volume fraction. The average forming and curing cycle time of a charge 22 in the form and cure tool 41 may be between 30 and 300 seconds, and in one embodiment, the time of the charge 22 in the form and cure tool 41 was 60 seconds. The cure time of the polymer is influenced by the polymer, the polymer formulation and the form and process tooling temperature. In comparison, a charge of composite material comprising an epoxy thermosetting resin of the same size and weight typically requires a cycle time of at least 10 minutes.

The tension grippers 32 in the cassette 31 minimize wrinkling of the composite material during the form and cure cycle and maintain the desired orientation of the fibers 16 in each ply during the formation of complex three dimensional parts. Instead of being part of a separate cassette 31 as shown, the tension grippers 32 may be integrated into the form and cure tool 41. The manufacturing process can be used, for example, to form relatively large, high volume automobile parts, such as floor pans, roofs, hoods, deck lids, and lift gates.

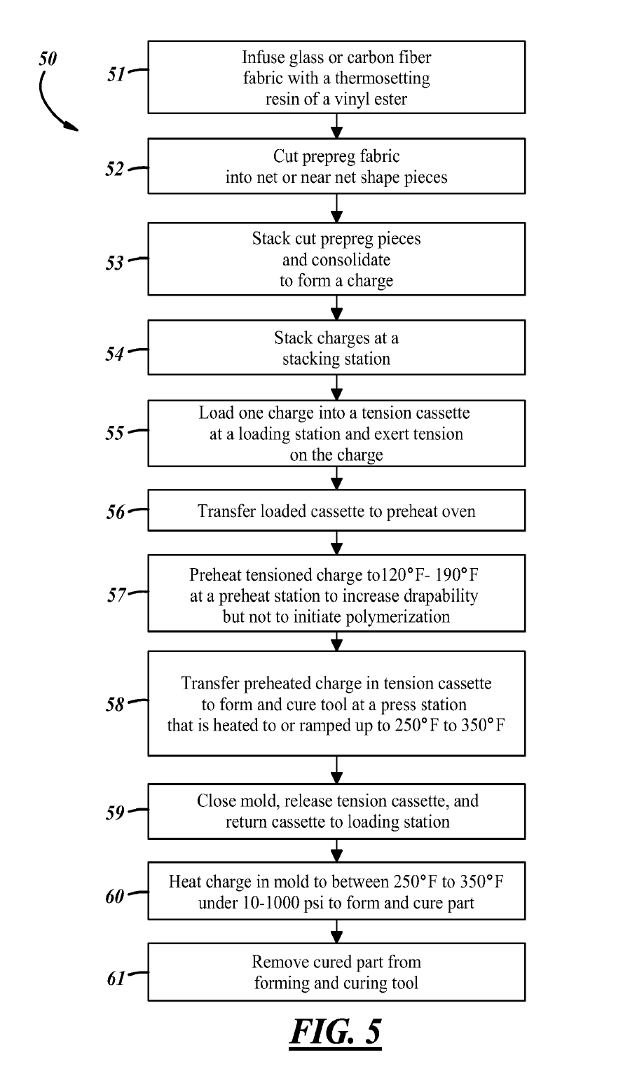

FIG. 5 shows the steps of the process 50 for manufacturing a composite part using the apparatus as described above. In step 51, glass or carbon fiber reinforcement may be infused with a thermosetting resin of a vinyl ester to create a prepreg. In step 52, the prepreg material may be cut into net or near net shape pieces. In step 53, the cut prepreg pieces may be stacked and pre-consolidated to form a charge. In step 54, the charges may be stacked at a stacking station. In step 55, the charges may be loaded at a loading station into grippers on a cassette, and the grippers may be used to exert a tension on the charge. In step 56, the loaded cassette may be transferred into a pre-heat oven. In step 57, the tensioned charge may be preheated in the pre-heat oven. For a thermoset polymer, the preheat temperature is high enough to increase the drapability of the charge, but low enough so that polymerization is not initiated. In step 58, the preheated charge in the tension cassette may be transferred into a form and cure tool that is set or ramped up to 250-350° F. In step 59, the forming and cure tool may be closed, and the tension cassette releases the charge and returns to the loading station to engage a new charge. In step 60, the forming and curing tool may be used to heat the thermoset charge to between 250° F. and 350° F. under 10-1000 PSI, and more particularly under 100-300 PSI to form and cure the part. In step 61, the cured part may be removed from the forming and curing tool. The forming and curing cycle time may be as little as sixty seconds. The rapid cycle time in the forming and curing tool in step 60 is enabled by a combination of the use of the vinyl ester resin in step 51 and preheating the charge in step 57 to the preheat temperature prior to placing it in the forming and curing tool. The cycle time for prior art processes for forming a similar part using an epoxy type prepreg polymer is ten minutes or more.

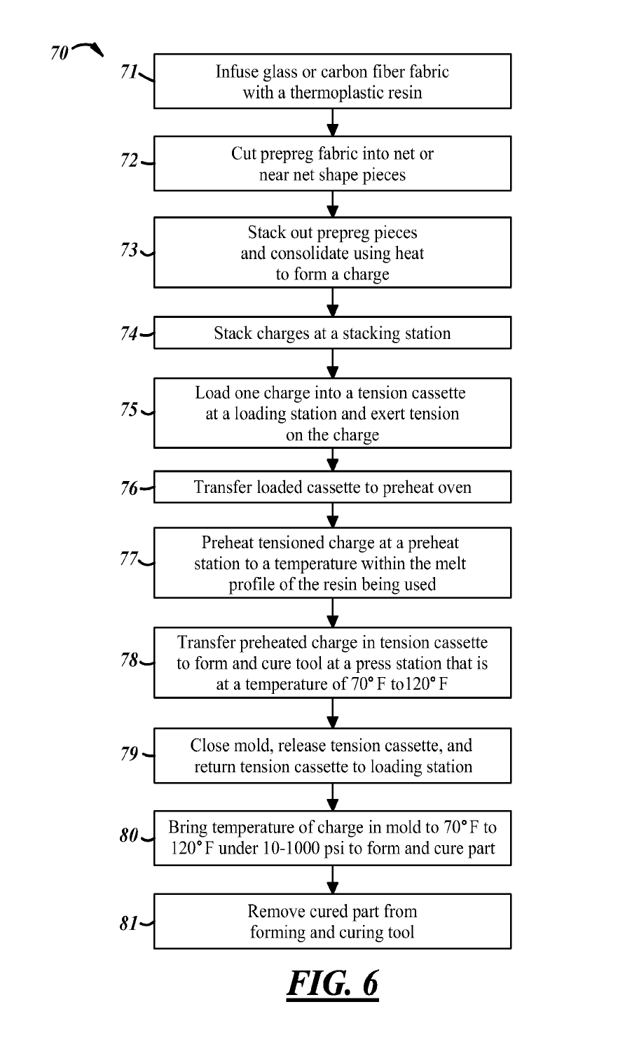

The process described above may also be applied to prepreg that is infused with thermoplastic resin according to the process 70 as shown in FIG. 6. In step 71, glass or carbon fiber reinforcement may be infused with a thermoplastic resin to create a prepreg. In step 72, the prepreg material may be cut into net or near net shape pieces. In step 73, the cut prepreg pieces may be stacked and pre-consolidated using heat to form a charge. In step 74, the charges may be stacked at a stacking station. In step 75, a charge may be loaded at a loading station into grippers on a cassette, and the grippers may be used to exert a tension on the charge. In step 76, the loaded cassette may be transferred into a pre-heat oven. In step 77, the tensioned charge may be preheated in the pre-heat oven. For a thermoplastic prepreg material the preheat temperature is typically within the melt profile of the polymer that is being used. In step 78, the preheated charge in the tension cassette may be transferred into a form and cure tool that is set to 70° F-120° F. In step 79, the form and cure tool may be closed, and the tension cassette may be returned to the loading station to engage a new charge. In step 80, the form and cure tool may be brought to a temperature of 70° F-120° F. to form and cure the part. In step 81, the cured part may be removed from the form and cure tool. As in the process using a thermoset resin, when using the thermoplastic resin, the tension grippers minimize wrinkling of the composite material during the form and cure cycle and maintain the desired orientation of the fibers in each ply during the formation of complex three dimensional parts.

Having thus described the device, various modification and alterations will occur to those skilled in the art, which modification and alterations will be within the scope of the invention as defined by the appended claims.

1. A method for molding a composite structure into a part, the method comprising the following sequence of steps:
infusing a fabric with a resin to form a ply of composite material comprising a resin infused fabric;
stacking a number of plies of composite material to form a charge;
placing the charge in a tension cassette and engaging the charge with grippers to maintain the relative alignment and orientation of the plies of the charge relative to one another;
placing the charge under tension in the tension cassette;
transferring the charge of composite material in the tension cassette to a preheat station;
preheating the of composite material at the preheat station to a preheat temperature that renders the composite material more drapable but is less than a temperature that causes the resin in the material to initiate polymerization and maintaining the tension on the charge in the cassette while it is being preheated;
transferring the charge of composite material in the tension cassette to a press station; and
heating the charge of composite material at the press station to a temperature that causes the resin to initiate polymerization, whereby the curing time for the composite material is substantially less than the curing time of a fabric that is infused with an epoxy resin.

2. (canceled)

3. The method of claim 2 further comprising:
maintaining the tension on the charge of composite material when it is being heated at the press station.

4. The method of claim 1 further comprising:
using a form and cure assembly at the press station that includes press platens to heat the charge of composite material to a temperature that causes the resin to initiate polymerization.

5. The method of claim 1 further comprising:
varying the tension across the charge of composite material depending on the final shape of the part.

6. (canceled)

7. (canceled)

8. The method of claim 1 further comprising:
exerting a tension on the charge from at least the time when the charge is being pre-heated in the preheat station to the time that the charge is being heated in the press station.

9. (canceled)

10. The method of claim 1 further comprising:
selecting the resin from a group consisting of thermosetting and thermoplastic resins.

11. The method of claim 10 wherein the resin is solid at room temperature and can be stored for a period of at least 6 months.

12. The method of claim 10 wherein the resin is a thermosetting resin.

13. The method of claim 12 wherein the thermosetting resin is a vinyl ester.

14. The method of claim 10 wherein the resin is a thermoplastic resin.

15. The method of claim 3 further comprising:
varying the tension exerted by the grippers on the charge depending on the final shape of the part.

16. The method of claim 11 further comprising:
making selective relief cuts in the plies of composite material to enable the material to be molded into a final shape without exerting excess stress on the fibers in the plies.

17. The method of claim 1 further comprising:
providing heating elements at the preheat station; and
individually controlling the heating elements to create heating zones within the preheat station in order to heat selected sections of the charge to control drapability.

18. The method of claim 1 further comprising:
preheating the tensioned charge to a temperature of between 100° F. and 500° F. at the preheat station.

19. The method of claim 1 further comprising:
preheating the tensioned charge to a temperature of between 120° F. and 190° F. at the preheat station.

20. The method of claim 4 further comprising:
heating the charge in the form and cure assembly to a temperature of between 250° F. and 350° F.

21. The method of claim 4 further comprising:
heating the charge in the form and cure assembly to a temperature of between 70° F. and 120° F.
